(19) United States
(12) Patent Application Publication
(10) Pub. No.: US 2020/0404758 A1
(43) Pub. Date: Dec. 24, 2020

(54) LIGHTING APPARATUS

(71) Applicant: XIAMEN LEEDARSON LIGHTING CO.LTD., Xiamen (CN)

(72) Inventors: Changjing Zeng, Xiamen (CN); Yiwei Chen, Xiamen (CN)

(21) Appl. No.: 16/908,315

(22) Filed: Jun. 22, 2020

(30) Foreign Application Priority Data
Jun. 21, 2019 (CN) 201910541248.1

(51) Int. Cl. H05B 45/24; H05B 47/19; H05B 45/325

(52) U.S. Cl. CPC H05B 45/24; H05B 45/325; H05B 47/19

(57) ABSTRACT

The lighting apparatus includes a first LED module, a second LED module and a third LED module. The first LED module emits a first light of a first color temperature. The second LED module emits a second light of a second color temperature. The third LED module emits a third light of a third color temperature. The driver is used for generating a first driving power, a second driving power and a third driving power respectively supplying to the first LED module, the second LED module and the third LED module. The controller is for determining a power ratio corresponding to a mixed light with a target color temperature mixed by the first light, the second light and the third light. The mixed lights of different target color temperatures have chroma coordinates within a predetermined chroma range.

### FIELD

The present invention is related to a lighting apparatus and more particularly related to a light apparatus with more flexible light parameter settings.

### BACKGROUND

The time when the darkness is being lighten up by the light, human have noticed the need of lighting up this planet. Light has become one of the necessities we live with through the day and the night. During the darkness after sunset, there is no natural light, and human have been finding ways to light up the darkness with artificial light. From a torch, candles to the light we have nowadays, the use of light have been changed through decades and the development of lighting continues on.

Early human found the control of fire which is a turning point of the human history. Fire provides light to bright up the darkness that have allowed human activities to continue into the darker and colder hour of the hour after sunset. Fire gives human beings the first form of light and heat to cook food, make tools, have heat to live through cold winter and lighting to see in the dark.

Lighting is now not to be limited just for providing the light we need, but it is also for setting up the mood and atmosphere being created for an area. Proper lighting for an area needs a good combination of daylight conditions and artificial lights. There are many ways to improve lighting in a better cost and energy saving. LED lighting, a solid-state lamp that uses light-emitting diodes as the source of light, is a solution when it comes to energy-efficient lighting. LED lighting provides lower cost, energy saving and longer life span.

The major use of the light emitting diodes is for illumination. The light emitting diodes is recently used in light bulb, light strip or light tube for a longer lifetime and a lower energy consumption of the light. The light emitting diodes shows a new type of illumination which brings more convenience to our lives. Nowadays, light emitting diode light may be often seen in the market with various forms and affordable prices.

After the invention of LEDs, the neon indicator and incandescent lamps are gradually replaced. However, the cost of initial commercial LEDs was extremely high, making them rare to be applied for practical use. Also, LEDs only illuminated red light at early stage. The brightness of the light only could be used as indicator for it was too dark to illuminate an area. Unlike modern LEDs which are bound in transparent plastic cases, LEDs in early stage were packed in metal cases.

In 1878, Thomas Edison tried to make a usable light bulb after experimenting different materials. In November 1879, Edison filed a patent for an electric lamp with a carbon filament and keep testing to find the perfect filament for his light bulb. The highest melting point of any chemical element, tungsten, was known by Edison to be an excellent material for light bulb filaments, but the machinery needed to produce super-fine tungsten wire was not available in the late 19th century. Tungsten is still the primary material used in incandescent bulb filaments today.

Early candles were made in China in about 200 BC from whale fat and rice paper wick. They were made from other materials through time, like tallow, spermaceti, colza oil and beeswax until the discovery of paraffin wax which made production of candles cheap and affordable to everyone. Wick was also improved over time that made from paper, cotton, hemp and flax with different times and ways of burning. Although not a major light source now, candles are still here as decorative items and a light source in emergency situations. They are used for celebrations such as birthdays, religious rituals, for making atmosphere and as a decor.

Illumination has been improved throughout the times. Even now, the lighting device we used today are still being improved. From the illumination of the sun to the time when human can control fire for providing illumination which changed human history, we have been improving the lighting source for a better efficiency and sense. From the invention of candle, gas lamp, electric carbon arc lamp, kerosene lamp, light bulb, fluorescent lamp to LED lamp, the improvement of illumination shows the necessity of light in human lives.

There are various types of lighting apparatuses. When cost and light efficiency of LED have shown great effect compared with traditional lighting devices, people look for even better light output. It is important to recognize factors that can bring more satisfaction and light quality and flexibility.

### SUMMARY

In some embodiments, a lighting apparatus includes a first LED module, a second LED module and a third LED module.

The first LED module emits a first light of a first color temperature. The second LED module emits a second light of a second color temperature. The third LED module emits a third light of a third color temperature.

The driver is used for generating a first driving power, a second driving power and a third driving power respectively supplying to the first LED module, the second LED module and the third LED module.

The controller is for determining a power ratio among the first driving power, the second driving power and the third driving power corresponding to a mixed light with a target color temperature mixed by the first light, the second light and the third light. The mixed lights of different target color temperatures have chroma coordinates being within a predetermined chroma range.

In some embodiments, the predetermined chroma range is corresponding to a Planckian locus.

In some embodiments, the chroma coordinates of different mixed lights with different target color temperatures are close to the Planckian locus within a predetermined threshold.

In some embodiments, the predetermined threshold is less than 10% of a maximum range.

In some embodiments, the controller has multiple chroma range options to select in addition to the Planckian locus.

In some embodiments, the lighting apparatus may also include a manual switch for a user to select one from the multiple chroma range options.

In some embodiments, the third LED module includes a color LED device adding a color component to adjust the chroma coordinate of the mixed light.

In some embodiments, multiple power ratios of the first driving power, the second driving power and the driving power are recorded in a memory device. The controller retrieves the power ratios and generates corresponding control signals to the driver to generate corresponding first driving powers, second driving powers, third driving powers for different target color temperatures.

In some embodiments, for target color temperatures not having corresponding power ratios, multiple adjacent power ratios are retrieved to calculate the power ratio by the controller.

In some embodiments, the lighting apparatus may also include a wireless module for receiving a table containing power ratios corresponding to different target color temperatures. The controller uses the table to control the driver to generate the first driving power, the second driving power and the third driving power.

In some embodiments, the lighting apparatus may also include a manual switch having multiple options corresponding to multiple target color temperatures, each option corresponds to one power ratio to be used by the controller.

In some embodiments, the first LED module has multiple chroma coordinates under different intensities, the different chroma coordinates under different intensities are referenced when determining the power ratios.

In some embodiments, a chroma measuring device is used for finding power ratios corresponding to different target color temperatures during manufacturing. The found power ratios are stored in a memory device used by the controller to determine the power ratios corresponding to target color temperatures.

In some embodiments, the driver includes a PWM circuit for generating the first driving power, the second driving power and the third driving power based on duty ratios for turning on the first LED module, the second LED module and the third LED modules corresponding to the power ratios.

In some embodiments, multiple sequence orders are mixed for turning on the first LED module, the second LED module and the third LED module.

In some embodiments, the first LED module, the second LED module and the third LED module share the same PWM circuit and only one of the first LED module, the second LED module and the third LED module is turned on at any given timing.

In some embodiments, the first LED module, the second LED module and the third LED module respectively have multiple LED devices, at least two LED devices from at least two of the first LED module, the second LED module, and the third LED module are turned on at a given timing.

In some embodiments, the power ratio corresponds to a first driving current, a second driving current and a third driving current continuously generated by the driver to drive the first LED module, the second LED module, and the third LED module.

In some embodiments, a mixed color rendering index is also considered to determine the power ratio corresponding to the target color temperature.

### BRIEF DESCRIPTION OF DRAWINGS

FIG. 1 illustrates a flowchart showing a method for adjusting a desired output.

FIG. 2 illustrates a lighting apparatus embodiment.

FIG. 3 shows a chroma space.

FIG. 4 shows a flowchart illustrating a method for calculating parameters.

FIG. 5 shows a structure as an embodiment.

FIG. 6 shows a flowchart for calculating parameters.

FIG. 7 shows another embodiment.

FIG. 8A shows an order sequence example in a PWM driving scheme.

FIG. 8B shows another order sequence example in a PWM driving scheme.

### DETAILED DESCRIPTION

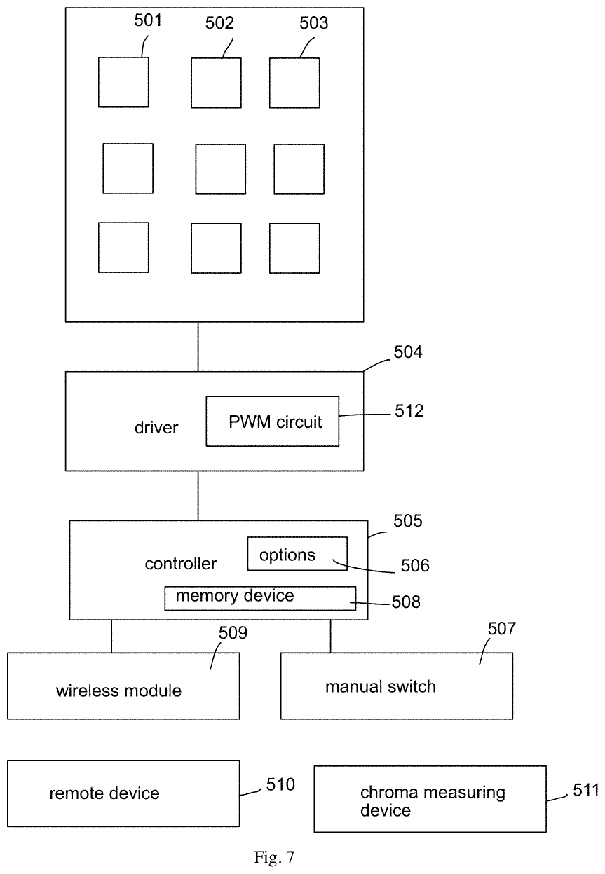

In FIG. 7, a lighting apparatus includes a first LED module 501, a second LED module 502 and a third LED module 503, a driver 504 and a controller 505.

The first LED module 501 emits a first light of a first color temperature. The second LED module 502 emits a second light of a second color temperature. The third LED module 503 emits a third light of a third color temperature.

The driver 504 is used for generating a first driving power, a second driving power and a third driving power respectively supplying to the first LED module 501, the second LED module 502 and the third LED module 503.

In some other embodiments, there may be more than three LED modules for mixing a desired color temperature. In such case, four or more LED modules are activated for mixing a desired target color temperature. In some other examples, three LED modules selected from more than three LED modules are used for mixing a target color temperature, but different three LED modules are selected corresponding to different color temperatures.

The controller 505 is for determining a power ratio among the first driving power, the second driving power and the third driving power corresponding to a mixed light with a target color temperature mixed by the first light, the second light and the third light. The mixed lights of different target color temperatures have chroma coordinates being within a predetermined chroma range.

In some embodiments, the predetermined chroma range is corresponding to a Planckian locus. For example, the mixed lights of different color temperatures respectively have chroma coordinates. The chroma coordinates among different color temperatures are falling close or directly on a curve line in a chroma space, e.g. a Planckian locus.

In physics and color science, the Planckian locus or black body locus is the path or locus that the color of an incandescent black body would take in a particular chromaticity space as the blackbody temperature changes. It goes from deep red at low temperatures through orange, yellowish white, white, and finally bluish white at very high temperatures.

A color space is a three-dimensional space; that is, a color is specified by a set of three numbers (the CIE coordinates X, Y, and Z, for example, or other values such as hue, colorfulness, and luminance) which specify the color and brightness of a particular homogeneous visual stimulus. A chromaticity is a color projected into a two-dimensional space that ignores brightness. For example, the standard CIE XYZ color space projects directly to the corresponding chromaticity space specified by the two chromaticity coordinates known as x and y, making the familiar chromaticity diagram shown in the figure. The Planckian locus, the path that the color of a black body takes as the blackbody temperature changes, is often shown in this standard chromaticity space.

The actual chroma coordinates may not fall directly on such curve line, but may be within a closed range of the curve line. For example, there are certain offsets from perfect coordinates of the desired curve line, and that is why the chroma range is used for describing such feature. Designers may determine the threshold, i.e. the accuracy of mimicking a desired curve line of chroma coordinates along color temperature variation.

In some embodiments, the chroma coordinates of different mixed lights with different target color temperatures are close to the Planckian locus within a predetermined threshold.

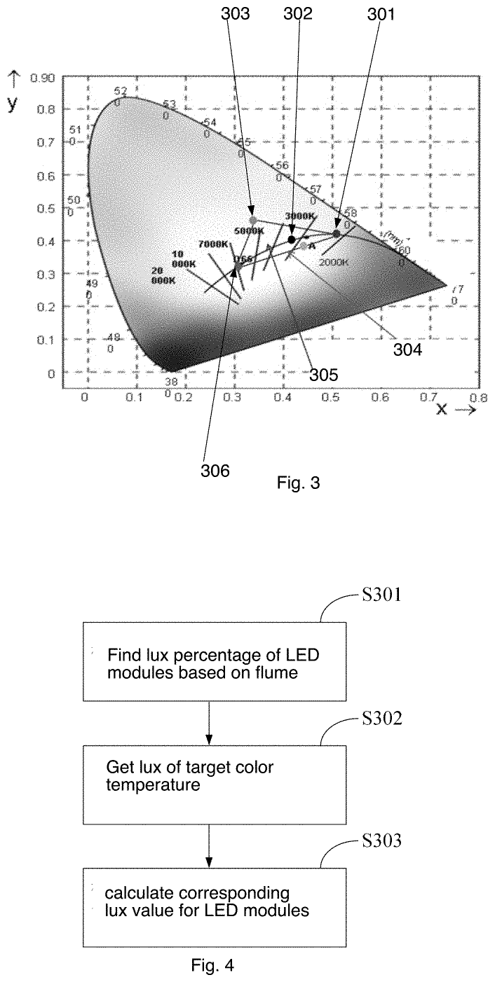

In some embodiments, the predetermined threshold is less than 10% of a maximum range. For example, FIG. 3 shows a popular chroma two-dimension space, the offset deviation from the perfect chroma range is less than 10%, if the difference between the coordinates with the perfect coordinates is found, the number is divided with a maximum value of the coordinates to be kept within 10%, which means it is close enough to the desired curve line in the chroma space.

In FIG. 7, the controller has multiple chroma range options 506 to select in addition to the Planckian locus.

In FIG. 7, the lighting apparatus may also include a manual switch 507 for a user to select one from the multiple chroma range options.

In some embodiments, the third LED module includes a color LED device adding a color component to adjust the chroma coordinate of the mixed light.

In FIG. 7, multiple power ratios of the first driving power, the second driving power and the driving power are recorded in a memory device 508. The controller retrieves the power ratios and generates corresponding control signals to the driver to generate corresponding first driving powers, second driving powers, third driving powers for different target color temperatures.

In some embodiments, for target color temperatures not having corresponding power ratios, multiple adjacent power ratios are retrieved to calculate the power ratio by the controller.

In FIG. 7, the lighting apparatus may also include a wireless module 509 for receiving a table from a remote device 510, the table containing power ratios corresponding to different target color temperatures. The controller uses the table to control the driver to generate the first driving power, the second driving power and the third driving power.

In some embodiments, the lighting apparatus may also include a manual switch having multiple options corresponding to multiple target color temperatures, each option corresponds to one power ratio to be used by the controller.

In some embodiments, the first LED module has multiple chroma coordinates under different intensities, the different chroma coordinates under different intensities are referenced when determining the power ratios.

In FIG. 7, a chroma measuring device 511 is used for finding power ratios corresponding to different target color temperatures during manufacturing. The found power ratios are stored in a memory device used by the controller to determine the power ratios corresponding to target color temperatures.

In FIG. 7, the driver includes a PWM circuit 512 for generating the first driving power, the second driving power and the third driving power based on duty ratios for turning on the first LED module, the second LED module and the third LED modules corresponding to the power ratios.

In some embodiments, multiple sequence orders are mixed for turning on the first LED module, the second LED module and the third LED module.

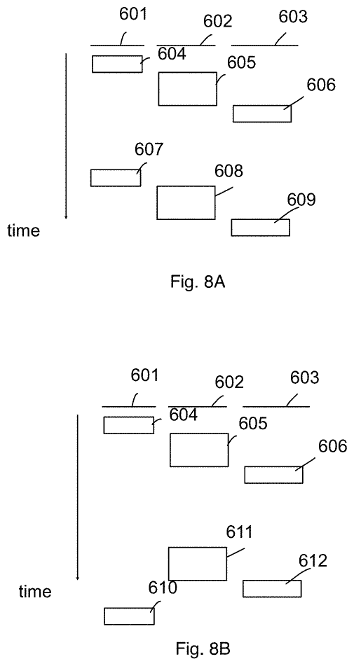

In FIG. 8A, the first LED module, the second LED module and the third LED module are turned according to timing sequence illustrated. Specifically, the three columns 601, 602, 603 correspond to turn-on status the first LED module, the second LED module and the third LED module.

In FIG. 8A, the first LED module is turned on for a time 604, the second LED module is turned on for a time 605 and then the third LED module is turned on for a time 606. A time break is provided corresponding to overall duty ratio of the LED modules. Then, the same order sequence for turning on the LED modules are kept, as shown in the time blocks 607, 608, 609.

In FIG. 8B, unlike FIG. 8A, the time blocks 610, 611, 612 to turn on the first LED module, the second LED module and the third LED module are different from previous order sequence. Such re-arrangement makes visual effect more stable, without showing a recognized pattern.

In some embodiments, the first LED module, the second LED module and the third LED module share the same PWM circuit and only one of the first LED module, the second LED module and the third LED module is turned on at any given timing.

In some embodiments, the first LED module, the second LED module and the third LED module respectively have multiple LED devices, at least two LED devices from at least two of the first LED module, the second LED module, and the third LED module are turned on at a given timing.

In some embodiments, the power ratio corresponds to a first driving current, a second driving current and a third driving current continuously generated by the driver to drive the first LED module, the second LED module, and the third LED module.

In some embodiments, a mixed color rendering index is also considered to determine the power ratio corresponding to the target color temperature.

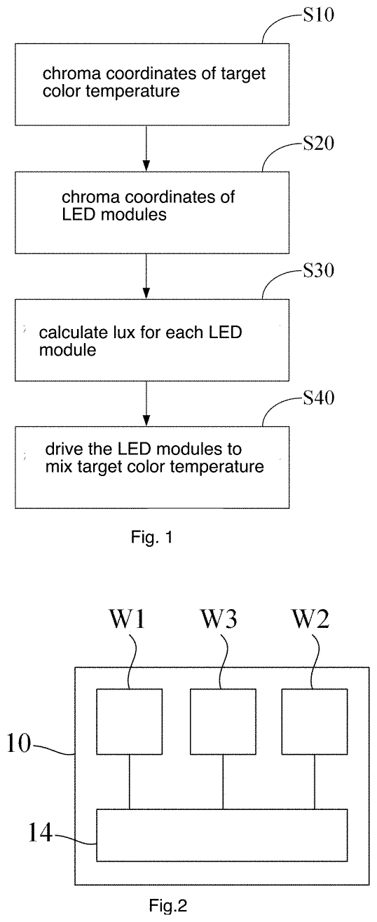

Please refer to FIG. 1. An embodiment provides a color temperature adjusting method includes at least the following steps.

STEP S10: Receiving color coordinates of a target color temperature.

Please refer to FIG. 3. In some embodiments, the color coordinates of the target color temperature refers to the color coordinates of the color temperature on the CIE1931 Chromaticity diagram which may be marked as T(x, y). The T of T(x, y) is the target color temperature and the unit is Kelvin (K). The (x, y) is the X direction and the Y direction coordinate of the color temperature on the Chromaticity diagram.

The chroma coordinate 303 correspond to the third LED module, the chroma coordinate 301 correspond to the first LED module, and the chroma coordinate 306 correspond to the second LED module. If only two LED modules, i.e. the first LED module and the second LED module, the mixed chroma coordinates follows a straight line 304. By adding the third LED module to mix the target color temperature, the chroma coordinates 305 of the output light is getting closer to the desired curve line, like the Pluckian locus.

The color coordinates of the target color temperature may be determined according to the need of a user. For example, the color coordinates of the target color temperature may be a color temperature related to different color coordinates on the color temperature line, the color coordinates on a Plunk curve of the Chromaticity diagram or the color coordinates of any other points on the Chromaticity diagram that may not be limited here. Optionally, the color coordinates of the target color temperature is on the Plunk curve for having a white light similar to a natural white light.

STEP S20: Receiving the color coordinates of every light source in a light source module.

Please refer to FIG. 2. In some embodiments. The light source module 10 provides an illumination light and the color temperature of the light may be adjusted. The light source module 10 includes at least a first white light source W1, a second white light source W2 and a third light source W3. The first white light source W1, the second white light source W2 and the third light W3 provide the light into the illumination light after light mixing. In order to have the illumination light after light mixing having the related color coordinates of the determined color temperature, Luminous flux of every light source of the light source module 10 may be adjusted. First of all, the color coordinates of each light source may be needed.

Every light source is determined, thus, the color temperature of every light source and the related color coordinates are determined. Take the light source module 10 including three light sources as an example, the color temperature and the color coordinates of the first white light source W1 are marked as T1(xW1, yW1). The T1 is the color temperature of the first white light source W1, and the (xW1, yW1) is the X direction and the Y direction coordinate on the Chromaticity diagram. The color temperature and the color coordinates of the second white light source W2 are marked as T2(xW2, yW2). The T2 is the color temperature of the second white light source W2, and the (xW2, yW2) is the X direction and the Y direction coordinate on the Chromaticity diagram. The color temperature and the color coordinates of the third light source W3 are marked as T3(xW3, yW3). The T3 is the color temperature of the third light source W3, and the (xW3, yW3) is the X direction and the Y direction coordinate on the Chromaticity diagram.

In some embodiments, the color coordinates of the first white light source W1 may be related to the color coordinate of the color temperature T1 on the color temperature line or may also be the coordinate of the color temperature T1 on the Plunk curve as long as the light is produced in white. The color coordinates of the second white light source W2 may be related to the color coordinate of the color temperature T2 on the color temperature line or may also be the coordinate of the color temperature T2 on the Plunk curve as long as the light is produced in white. It is understood as the first white light source W1 and the second white light source W2 have different color temperature and different color coordinates for ensuring every light source may be mixed.

STEP S30: According to the color coordinates of the target color temperature and the color coordinates of the target color temperature, find the Luminous flux of every light source.

As the description in S20, in some embodiments, the Luminous flux of every light source of the light source module 10 being adjusted for having the illumination light of every light source after light mixing, thus, the Luminous flux of every light source needs to be determined.

Please refer to FIG. 3. In an embodiment, the color coordinates of the first white light source W1, the second white light source W2 and the third white light source W3 are different. The color coordinates of the three light source on the Chromaticity diagram connect together forming a triangle, thus, the color coordinates of the illumination light of the three light sources after light mixing may be inside the trigonal area. The large of the area of the trigonal area, the more illumination light from different color coordinates it gets, the larger is the adjusting range.

According to the color coordinates of the target color temperature and the color coordinates of every light source for receiving the Luminous flux of the light source, ensures whether the color coordinates of the target color temperature are in the trigonal area formed by the color coordinates of the three light sources first. When the color coordinates of the target color temperature is inside the trigonal area, the Luminous flux may be received through the light mixing of the three light sources. When the color coordinates of the target color temperature is outside the trigonal area, the Luminous flux may not be received from the light mixing of the three light sources and may need the following steps. In some embodiments, the amount of the light source may be four or more, and the steps are familiar to the situation of three light sources.

STEP S40: According to the light mixing of the Luminous flux of every light source, the illumination light of the target color temperature may be needed.

After receiving the Luminous flux of every light source, only have to control the related Luminous flux produced by every light source and output the light of every light source after light mixing for having the illumination light of the target color temperature.

In an embodiment, the center of the color coordinates of the target color temperature may be on the Plunk curve and the related light to the Plunk curve is natural white light, thus, through the above ways for receiving the illumination light closed to the natural white light which has a great effect in illumination and also meets the need of a user.

In some embodiments, the advantage of the color temperature adjusting methods at least are that the light source module of the color temperature adjusting now often uses two color temperature of light sources. Through controlling the Luminous flux of the two light sources for adjusting the color temperature may enlarge the range of adjusting the color temperature but disregard the quality of the illumination light. The reason is that the coordinate of the light mixing of two color temperature are on the connecting line of the color coordinate of two light sources, thus, the light mixing often diverges from the Plunk curve of the white light, receiving the light tending red that produce a white light different from the natural white light.

In an embodiment shows a totally different way to adjust the color temperature of the light source and produce the illumination light similar to the natural white light. Specifically, in an embodiment, at least three different color temperature of light sources is provided. Two of the three light sources are white light. When the center of the color coordinates of the target color temperature is on the Plunk curve, through the adjustment of the Luminous flux of every light source which may let the center of the color coordinate of the illumination light after light mixing of every light source on the Plunk curve for ensuring the white light closed to the natural white light. The color tolerance meets the standard of the design and has a great effect in illumination which meets the need of the user. The center of the color coordinates of the target color temperature may be at the other position outside the Plunk curve as long as being in the area formed by every light source, through the above way may have the illumination light of the target color temperature and color coordinates.

Please refer to FIG. 4. In an embodiment, the STEP S30 includes:

STEP S301: According to the color coordinates of the target color temperature and the color coordinates of every light source, find a percentage of the Luminous flux of every light source.

In an embodiment, the amount of the light source is three as an example, the percentage of the Luminous flux of every light source may be valued through the following Formula 1:

$$[ \begin{matrix}{Y}_{W 1} \\ {Y}_{W 2} \\ {Y}_{W 3}\end{matrix} ] = {[ \begin{matrix}\frac{{x}_{W 1}}{{y}_{W 1}} & \frac{{x}_{W 2}}{{y}_{W 2}} & \frac{{x}_{W 3}}{{y}_{W 3}} \\ 1 & 1 & 1 \\ \frac{1 - {x}_{W 1} - {y}_{W 1}}{{y}_{W 1}} & \frac{1 - {x}_{W 2} - {y}_{W 2}}{{y}_{W 2}} & \frac{1 - {x}_{W 3} - {y}_{W 3}}{{y}_{W 3}}\end{matrix} ]}^{- 1} [ \begin{matrix}\frac{x}{y} \\ 1 \\ \frac{1 - x - y}{y}\end{matrix} ] \qquad Formula 1$$

In the Formula 1, Y_{W1} is the percentage of the Luminous flux of the first white light source.

Y_{W2} is the percentage of the Luminous flux of the second white light source.

Y_{W3} is the percentage of the Luminous flux of the third light source.

(x_{W1}, y_{W1}) is the color coordinates of the first white light source.

(x_{W2}, y_{W2}) is the color coordinates of the second white light source.

(x_{W3}, y_{W3}) is the color coordinates of the third light source.

(x, y) is the color coordinates of the target color temperature.

Through the above Formula 1, after having the color coordinates of the first white light source W1, the second white light source W2 and the third light source W3 and determined the color coordinates of the target color temperature, the percentage of the Luminous flux of the first white light source W1, the second white light source W2 and the third light source W3 may be valued through the Formula 1.

In an embodiment, the target color temperature may include multiple color temperatures in the range of one color temperature. For example, the range of the color temperature may be 1800K to 10000K. Take the range of the color temperature in 2200K to 6500K as an example, the color temperature of then may be 2200K, 2700K, 3000K, 3500K, 4000K, 4500K, 5000K, 5700K and 6500K. For every color temperature, after determining the related color coordinates of each color temperature, the percentage of the Luminous flux of the first white light source W1, the second white light source W2 and the third light source W3 may be valued through the Formula 1. The range of the color temperature may be other value and not be limited to the above description.

STEP S302: Receiving the Luminous flux of the target color temperature is marked as Φ and the unit is lumen (lm). The Luminous flux of the illumination light with the target color temperature may adjust according to the need.

STEP S303: According to the Luminous flux of the illumination light of the target color temperature and the percentage of the Luminous flux of every light source for having the Luminous flux of the light source.

For example, the Luminous flux of the first white light source W1 is W1 is ϕ1=ϕYW1, the Luminous flux of the second white light source W2 is ϕ2=ϕYW2 and the Luminous flux of the third light source is ϕ3=ϕYW3 for having the Luminous flux of every light source.

In an embodiment, through the above ways for receiving the illumination light, the color tolerance of every color temperature is less than or equal to 4 SDCM (Standard Deviation Color matching) which meet the needs of the user for the use of the color tolerance under each color temperature but also achieve the requirement of the North American market.

Please refer to FIG. 3. In an embodiment, the color coordinates of the first white light source W1 and the color coordinates of the second white light source W2 are both on the Plunk curve. Considering the features of the Plunk curve, the color coordinates of the third light source W3 is above the Plunk curve, the first white light source W1, the second white light source W2 and the third light source W3 form a trigonal area. In the trigonal area includes the Plunk curve between the color temperature of the first white light source W1 and the second white light source W2. Thus, through the adjustment of the Luminous flux of the first white light source W1, the second white light source W2 and the third light source W3 for receiving the white light of the color coordinates on the Plunk curve.

Specifically, the third light source W3 is a green light source which the color coordinates on the Chromaticity diagram is above the Plunk curve for producing green light area. While the first white light source W1, the second white source W2 and the third white light source W3 forms a trigonal area which have a larger area for adjusting the color temperature of the illumination light and the color coordinates in a larger area.

In the following embodiment, the light source 10 includes the first white light source W1, the second white light source W2 and the third light source W3. Among them, the color temperature of the first white light source is 2200K, the color temperature of the second white light source 11 is 6500K, so the adjusting range of the color temperature of the light source module 10 is 2200K to 6500K. The illumination light produces by the light source module 10 is white light and the color coordinates of the white light is on the Plunk curve. The illumination light of the target color temperature and the related color coordinates is shown below:

| | Color | X | Y |
|---|---|---|---|
| Type | Temperature | Coordinate | Coordinate |
| First White | 2200 K | 0.5018 | 0.4153 |
| Light Source | | | |
| Second White | 6500 K | 0.3123 | 0.3283 |
| Light Source | | | |
| Third Light Source | | 0.35 | 0.45 |
| Illumination Light | 2700 K | 0.4578 | 0.4101 |
| | 3000 K | 0.4339 | 0.4033 |
| | 3500 K | 0.4073 | 0.393 |
| | 4000 K | 0.3818 | 0.3797 |
| | 4500 K | 0.3613 | 0.367 |
| | 5000 K | 0.3446 | 0.3551 |
| | 5700 K | 0.3287 | 0.3425 |

Considering the Luminous flux ϕ of the illumination light produced by the light source module 10 is 1000 lm (lumen). According to the percentage of the Luminous flux of every light source, receiving the Luminous flux of every light source is shown in the following chart.

| Light | First White | Second White | Third |
|---|---|---|---|
| Source | Light Source | Light Source | Light Source |
| 2200 K | 100% | 0% | 0% |
| 2700 K | 74.9% | 9.4% | 15.7% |
| 3000 K | 62.4% | 17.4% | 20.2% |
| 3500 K | 49.2% | 29.1% | 21.7% |
| 4000 K | 36.1% | 41.8% | 22.1% |
| 4500 K | 25.8% | 55.2% | 19.0% |
| 5000 K | 17.3% | 68.0% | 14.7% |
| 5700 K | 9.0% | 82.6% | 8.4% |
| 6500 K | 0% | 100% | 0% |

Finally, according to the Luminous flux, controlling the Luminous flux of the first white light source W1, the second white light source W2 and the third light source W3 and then light mixing for receiving the illumination light closed to the natural white light, and the color tolerance related to each of the color temperature is less than and equal to 4 SDCM which meets the standard of design and has a better color consistency for lighting.

| Light | First White | Second White | Third |
|---|---|---|---|
| Source | Light Source | Light Source | Light Source |
| 2200 K | 1000 lm | 0 | 0 |
| 2700 K | 749 lm | 94 lm | 157 lm |
| 3000 K | 624 lm | 174 lm | 202 lm |
| 3500 K | 492 lm | 291 lm | 217 lm |
| 4000 K | 361 lm | 418 lm | 221 lm |
| 4500 K | 258 lm | 552 lm | 190 lm |
| 5000 K | 173 lm | 680 lm | 147 lm |
| 5700 K | 90 lm | 826 lm | 84 lm |
| 6500 K | 0 | 1000 lm | 0 |

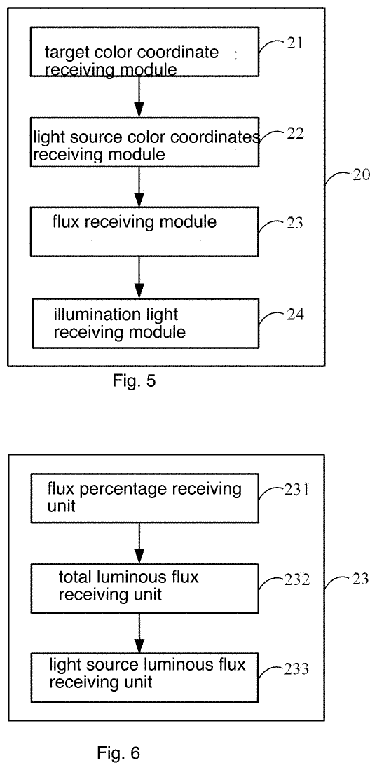

Please refer to FIG. 5. In an embodiment, a color temperature adjusting device 20 is provided. The color temperature adjusting device 20 includes a target color coordinates receiving module 21, a light source color coordinates receiving module 22, a light source Luminous flux receiving module 23 and an illumination light receiving module 24. Among them, the target color coordinates receiving module 21 is for receiving the color coordinates of the target color temperature. The light source color coordinates receiving module 22 is for receiving the color coordinates of the light source in the light source module. The light source module includes ate least the first white light source, the second white light source and the third light source. The light source Luminous flux receiving module 23 is for receiving the Luminous flux of the light source according to the color coordinates of the target color temperature. The illumination light receiving module 24 is for receiving the illumination light with the target color temperature according to the light mixing of the Luminous flux of the light source.

Please refer to FIG. 6. Specifically, the light source Luminous flux receiving module 23 includes a Luminous flux percentage receiving unit 231, a total Luminous flux receiving unit 232 and a light source Luminous flux receiving unit 233. Among them, the Luminous flux percentage receiving unit 231 is for receiving the percentage of the Luminous flux according to the color coordinates of the target color temperature and every light source. The total Luminous flux receiving unit 232 is for receiving the Luminous flux of the illumination light of the target color temperature. The light source Luminous flux receiving unit 233 is for receiving the Luminous of every light source according to the Luminous flux of the illumination of the target color temperature and the percentage of the Luminous flux of every light source.

Please refer to FIG. 2. In an embodiment, a light source module 10 is provided for providing the illumination light and the color temperature of the illumination light is adjustable. The light source 10 includes at least the first white light source W1, the second white light source W2 and the third light source. Among them, the first white light source W1, the second white light source W2 and the third light source provide the illumination light after light mixing. Through the adjustment of the Luminous flux of the first white light source W1, the second white light source W2 and the third light source W3, every standard of the illumination light after light mixing may be adjusted. For example, the color coordinates on the Chromaticity diagram, the color temperature and the color tolerance . . . etc.

In an embodiment, the first white light source W1, the second white light source W2 and the third light source W3 may be LED light source. The light source module 10 also includes a control unit 14. The control unit 14 and the first white light source W1, the second white light source W2 and the third light source W3 is connected together, at least for using to control the luminous flux of the first white light source W1, the second white light source W2 and the third light source W3 that the color temperature produced by the light source module 10 may be adjusted. The color temperature of the illumination light is adjusted in the way being described above for providing the white light which is closed to the natural white light. The related color tolerance of each color temperature is less than or equal to 4 SDCM. The color tolerance meets the standard of the design and has a great effect in illumination which meets the need of the user.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus comprising:
a first LED module emitting a first light of a first color temperature;
a second LED module emitting a second light of a second color temperature;
a third LED module emitting a third light of a third color temperature;
a driver for generating a first driving power, a second driving power, a third driving power respectively supplying to the first LED module, the second LED module and the third LED module; and
a controller for determining a power ratio among the first driving power, the second driving power and the third driving power corresponding to a mixed light with a target color temperature mixed by the first light, the second light and the third light, the mixed lights of different target color temperatures having chroma coordinates being within a predetermined chroma range.

2. The lighting apparatus of claim 1, wherein the predetermined chroma range is corresponding to a Planckian locus.

3. The lighting apparatus of claim 2, wherein the chroma coordinates of different mixed lights with different target color temperatures are close to the Planckian locus within a predetermined threshold.

4. The lighting apparatus of claim 3, wherein the predetermined threshold is less than 10% of a maximum range.

5. The lighting apparatus of claim 2, wherein percentages of the Luminous flux of the first LED module, the second LED module and the third LED module are calculated based on following Formula 1:
$$[ \begin{matrix}{Y}_{W 1} \\ {Y}_{W 2} \\ {Y}_{W 3}\end{matrix} ] = {[ \begin{matrix}\frac{{x}_{W 1}}{{y}_{W 1}} & \frac{{x}_{W 2}}{{y}_{W 2}} & \frac{{x}_{W 3}}{{y}_{W 3}} \\ 1 & 1 & 1 \\ \frac{1 - {x}_{W 1} - {y}_{W 1}}{{y}_{W 1}} & \frac{1 - {x}_{W 2} - {y}_{W 2}}{{y}_{W 2}} & \frac{1 - {x}_{W 3} - {y}_{W 3}}{{y}_{W 3}}\end{matrix} ]}^{- 1} [ \begin{matrix}\frac{x}{y} \\ 1 \\ \frac{1 - x - y}{y}\end{matrix} ] \qquad Formula 1$$
, in the Formula 1, Y_{W1} is the percentage of the Luminous flux of the first white light source,
Y_{W2} is the percentage of the Luminous flux of the second white light source,
Y_{W3} is the percentage of the Luminous flux of the third light source,
(x_{W1}, y_{W1}) is the color coordinates of the first white light source,
(x_{W2}, y_{W2}) is the color coordinates of the second white light source,
(x_{W3}, y_{W3}) is the color coordinates of the third light source, and
(x, y) is the color coordinates of the target color temperature.

6. The lighting apparatus of claim 1, wherein the controller has multiple chroma range options to select in addition to the Planckian locus.

7. The lighting apparatus of claim 6, further comprising a manual switch for a user to select one from the multiple chroma range options.

8. The lighting apparatus of claim 1, wherein the third LED module comprises a color LED device adding a color component to adjust the chroma coordinate of the mixed light.

9. The lighting apparatus of claim 1, wherein multiple power ratios of the first driving power, the second driving power and the driving power are recorded in a memory device, the controller retrieves the power ratios and generates corresponding control signals to the driver to generate corresponding first driving powers, second driving powers, third driving powers for different target color temperatures.

10. The lighting apparatus of claim 9, wherein for target color temperatures not having corresponding power ratios, multiple adjacent power ratios are retrieved to calculate the power ratio by the controller.

11. The lighting apparatus of claim 9, further comprising a wireless module for receiving a table containing power ratios corresponding to different target color temperatures, the controller uses the table to control the driver to generate the first driving power, the second driving power and the third driving power.

12. The lighting apparatus of claim 1, further comprising a manual switch having multiple options corresponding to multiple target color temperatures, each option corresponds to one power ratio to be used by the controller.

13. The lighting apparatus of claim 1, wherein the first LED module has multiple chroma coordinates under different intensities, the different chroma coordinates under different intensities are referenced when determining the power ratios.

14. The lighting apparatus of claim 1, wherein a chroma measuring device is used for finding power ratios corresponding to different target color temperatures during manufacturing, the found power ratios are stored in a memory device used by the controller to determine the power ratios corresponding to target color temperatures.

15. The lighting apparatus of claim 1, wherein the driver comprises a PWM circuit for generating the first driving power, the second driving power and the third driving power based on duty ratios for turning on the first LED module, the second LED module and the third LED modules corresponding to the power ratios.

16. The lighting apparatus of claim 15, wherein multiple sequence orders are mixed for turning on the first LED module, the second LED module and the third LED module.

17. The lighting apparatus of claim 15, wherein the first LED module, the second LED module and the third LED module share the same PWM circuit and only one of the first LED module, the second LED module and the third LED module is turned on at any given timing.

18. The lighting apparatus of claim 15, wherein the first LED module, the second LED module and the third LED module respectively have multiple LED devices, at least two LED devices from at least two of the first LED module, the second LED module, and the third LED module are turned on at a given timing.

19. The lighting apparatus of claim 1, wherein the power ratio corresponds to a first driving current, a second driving current and a third driving current continuously generated by the driver to drive the first LED module, the second LED module, and the third LED module.

20. The lighting apparatus of claim 1, wherein a mixed color rendering index is also considered to determine the power ratio corresponding to the target color temperature.
